(19) United States
(12) Patent Application Publication
(10) Pub. No.: US 2015/0264756 A1
(43) Pub. Date: Sep. 17, 2015

(54) CIRCUIT FOR ADJUSTING COLOR TEMPERATURE AND LUMINOUS FLUX OF LIGHT EMITTING DIODES

(71) Applicant: DONGGUAN JIASHENG LIGHTING TECHNOLOGY CO., LTD., Dongguan City (CN)

(72) Inventor: Shuisheng Xu, Dongguan City (CN)

(21) Appl. No.: 14/325,459

(22) Filed: Jul. 8, 2014

(30) Foreign Application Priority Data
Mar. 11, 2014 (CN) 201420107571.0

(51) Int. Cl. H05B 33/08

(52) U.S. Cl. CPC H05B 33/0809; H05B 33/0857; H05B 33/0845; H05B 33/0821

(57) ABSTRACT

A circuit for adjusting color temperature and luminous flux of LEDs is provided. The circuit includes a first AC receiving terminal, a second AC receiving terminal, an SCR, a power source module and a load module. The power source module includes two input terminals and two output terminals, the two input terminals are connected to the first AC receiving terminal and the second AC receiving terminal respectively, the SCR is connected between the first AC receiving terminal and one of the input terminals of the power source module, the load module is connected between the two output terminals of the power source module and includes at least two load units connected in parallel, each of the at least two load units includes a plurality of LEDs connected in series, at least one of the at least two load units includes a resistor connected with the LEDs therein.

### CROSS-REFERENCE TO RELATED APPLICATIONS

The present application claims priority to Chinese Patent Application No. 201420107571.0, filed on Mar. 03 2014, which is hereby incorporated by reference in its entirety.

### FIELD OF THE APPLICATION

The present disclosure generally relates to light emitting diodes (LEDs), and more particularly, to a circuit for adjusting color temperature and luminous flux of LEDs.

### BACKGROUND

LEDs are used as light sources of LED lamps, and because an LED is a kind of solid-state cold light source having such features as environmental, no pollution, low power consumption, high luminous efficiency, a long service life, and so on, the LEDs are widely applied. In daily life, requirements of different people for lamplight are different. For example, somebody likes brighter lamplight and somebody likes darker lamplight. Color temperature of lamplight may need to be slightly red in some application, and sometimes the color temperature of lamplight possibly may need to be slightly warm or yellow in other application. In particularly, luminous flux and color temperature of lamplight of a commercial LED often need to be changed according to different display effects such as a kind, a gloss, a texture and three-dimensional display of a commodity. However, an existing driving circuit of the LED can only adjust luminous flux of the LED, awhile the color temperature of the LED cannot be adjusted at the same time.

### SUMMARY

A circuit for adjusting color temperature and luminous flux of LEDs includes a first alternating current (AC) receiving terminal; a second AC receiving terminal; a power source module comprising two input terminals and two output terminals, the two input terminals being connected to the first AC receiving terminal and the second AC receiving terminal respectively; a silicon controlled rectifier (SCR) connected between the first AC receiving terminal and one of the input terminals of the power source module; and a load module connected between the two output terminals of the power source module, the load module includes at least two load units connected in parallel with each other, each of the at least two load units includes a plurality of LEDs connected in series with each other, and at least one of the at least two load units comprises a resistor connected with the LEDs therein.

### BRIEF DESCRIPTION OF THE DRAWINGS

To describe the technical solutions of the embodiments of the present application or prior art more clearly, the accompanying drawings for the embodiments of the present application or the prior art are briefly described. Apparently, the accompanying drawings are not exhaustive, and persons of ordinary skill in the art can derive other drawings without any creative effort.

FIG. 1 is a circuit diagram of a circuit for adjusting color temperature and luminous flux of LEDs according to a first embodiment of the present disclosure; and

FIG. 2 is a circuit diagram of a circuit for adjusting color temperature and luminous flux of an LED according to a second embodiment of the present disclosure.

### DETAILED DESCRIPTION

To make the objectives, features, and advantages of the present application clearer and more understandable, the following describes the embodiments of the present application in detail with reference to accompanying drawings.

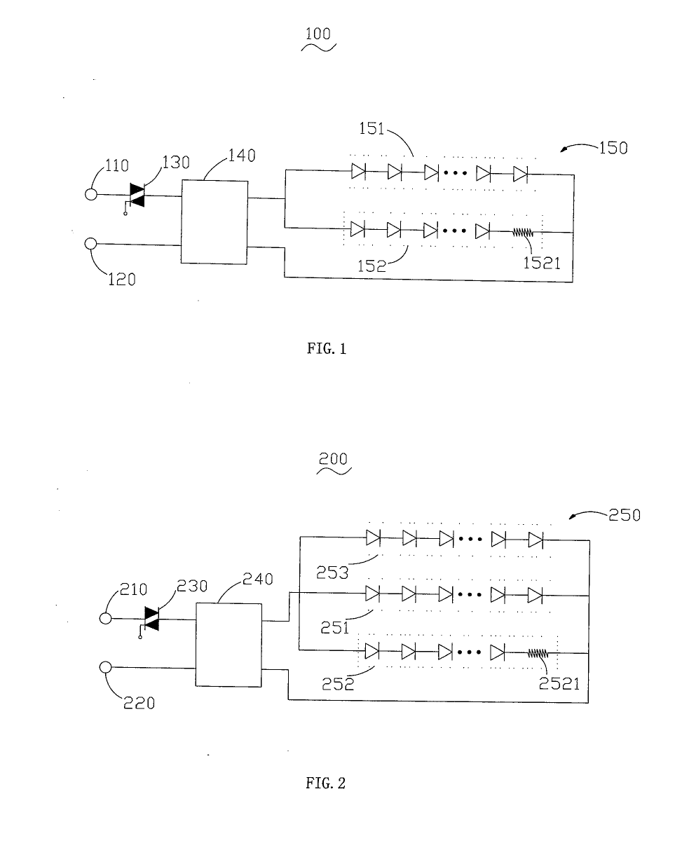

Referring to FIG. 1, FIG. 1 is a circuit diagram of a circuit for adjusting color temperature and luminous flux of LEDs according to a first embodiment of the present disclosure. The circuit 100 includes a first alternating current (AC) receiving terminal 110, a second AC receiving terminal 120, a silicon controlled rectifier (SCR) 130, a power source module 140 and a load module 150.

The first AC receiving terminal 110 and the second AC receiving terminal 120 are used to receive an AC supply voltage, for example, a 220 V AC voltage of commercial power. The power source module 140 includes two input terminals and two output terminals, the two input terminals are connected to the first AC receiving terminal 110 and the second AC receiving terminal 120 respectively. The power source module 140 may also include a rectifier and filter circuit (not shown). The rectifier and filter circuit is configured to rectify and filter an AC supply voltage received from the first AC receiving terminal 110 and the second AC receiving terminal 120 and obtain a stable direct current (DC) voltage.

The SCR 130 is connected between the first AC receiving terminal 110 and one of the input terminals of the power source module 140. The SCR 130 is configured to adjust a phase angle of the AC supply voltage received by the power source module 140 from the first AC receiving terminal 110, so as to change an output voltage of the power source module 140. The load module 150 is connected between the two output terminals of the power source module 140.

The power source module 140 rectifies and filters the AC supply voltage received from the first AC receiving terminal 110 and the second AC receiving terminal 120 to obtain the DC voltage, and outputs the DC voltage to the load module 150. In a specific embodiment, the load module 150 may include at least two load units. For example, in the embodiment shown in FIG. 1, the load module 150 includes a first load unit 151 and a second load unit 152 connected in parallel with each other. Each of the first load unit 151 and the second load unit 152 includes a plurality of LEDs connected in series, and the second load unit 152 further includes a resistor 1521 connected with the LEDs therein. Color temperature of the LEDs of the first load unit 151 is different from that of the LEDs of the second load unit 152. For example, the color temperature of the LEDs of the first load unit 151 may be 4000 K, and the color temperature of the LEDs of the second load unit 152 may be 2000 K.

An operation of the circuit 100 for adjusting color temperature and luminous flux of LEDs is as follows.

The SCR 130 is adjusted to change a phase angle of an AC supply voltage received by the power source module 140, so as to change an output voltage of the power source module 140, and accordingly, a current of the first load unit 151 and a current of the second load unit 152 of the load module 150 are also changed. As such, an overall color temperature of the load module 150 is adjusted.

When the SCR 130 is turned to a maximum value, a voltage of the first load unit 151 is substantially the same as that of the second load unit 152, and a current flowing through the first load unit 151 is also the same as that flowing through the second load unit 152. In this circumstance, the color temperature of the LEDs of the first load unit 151 may be 4000 K and the color temperature of the LEDs of the second load unit 152 may be 2000 K, and thus an overall color temperature is about 3000 K.

When the SCR 130 is turned down, the voltages the first load unit 151 and the second load unit 152 are both decreased, and the currents flowing through the first load unit 151 and the second load unit 152 are also descreased. Because the first load unit 151 and the second load unit 152 of the load module 150 are connected in parallel, the voltage of the first load unit 151 retains to be substantially the same as that of the second load unit 152, and thus decrements of the voltages thereof are the same. However, the second load unit 152 is connected in series with the resistor 1521, due to a current limiting effect of the resistor 1521, decrements of the currents flowing the first load unit 151 and the second load unit 152 are different. In particular, the current flowing through the first load unit 151 is decreased faster than the current flowing through the second load unit 152. Accordingly, the current flowing through the second load unit 152 is greater than the current flowing through the first load unit 151. The overall color temperature is decreased with decreases of the currents, and is near to a color temperature of a load with a large current, that is, the color temperature of the LED of the second load unit 152. As the SCR 130 is further turned down, a difference between the currents flowing through the first load unit 151 and the second load unit 152 is further increased, and accordingly the overall color temperature is decreased to the color temperature of the LED of the second load unit 152.

In addition, the voltage of the load module 150 is changed when the SCR 130 is turned down, because luminous flux of the LEDs is in direct proportion to the voltage, the luminous flux of the LEDs of the load module 150 can also be adjusted.

In the circuit 100 for adjusting color temperature and luminous flux of LEDs provided by the present disclosure, the SCR 130 is adjusted to change a phase angle of an

AC supply voltage received by the power source module 140, so as to change an output voltage of the power source module 140. The second load unit 152 connected in parallel with the first load unit 151 is connected in series with the resistor 1521. Due to the current limiting effect of the resistor 1521, a current difference exists between the first load unit 151 and the second load unit 152, so that the overall color temperature of the load module 150 is adjusted. Moreover, luminous flux of the LEDs of the load module 150 is also adjusted because the voltage of the load module 150 is changed. Therefore, the circuit 100 for adjusting color temperature and luminous flux of LEDs provided by the present disclosure can not only adjust the luminous flux of the LEDs but also adjust the color temperature of the LEDs.

Referring to FIG. 2, FIG. 2 is a circuit diagram of a circuit for adjusting color temperature and luminous flux of LEDs provided by a second embodiment of the present disclosure. The circuit 200 is similar to the circuit 100 for adjusting color temperature and luminous flux of LEDs as shown in FIG. 1. The main difference is that a load module 250 of the circuit 200 includes a first load unit 251, a second load unit 252 and a third load unit 253 connected in parallel with each other. Each of the first load unit 251, the second load unit 252 and the third load unit 253 includes a plurality of LEDs connected in series with each other. The second load unit 252 includes a resistor 2521 connected with the LEDs therein. The third load unit 253 may also include a resistor (not shown) with a resistance value different from that of the resistor 2521 in second load unit 252. In the load module 250 of the circuit 200 according to this embodiment, multiple load units connected in parallel can improved a reliability of the load module 250, in other words, if one of the load units is damaged, other load units is not affected and thus the normal use of the load module 250 can be ensured.

Although the principle and implementations are described with reference to some exemplary embodiments, the above mentioned embodiments are only intended to help understand the claims. It is apparent that those skilled in the art can make modifications and variations to the embodiments without departing from the spirit and scope of the claims. Therefore, the content of the specification shall not be construed as a limitation on the claims.

What is claimed is:

1. A circuit for adjusting color temperature and luminous flux of light emitting diodes (LEDs), comprising:
a first alternating current (AC) receiving terminal;
a second AC receiving terminal;
a power source module comprising two input terminals and two output terminals, the two input terminals being connected to the first AC receiving terminal and the second AC receiving terminal respectively;
a silicon controlled rectifier (SCR) connected between the first AC receiving terminal and one of the input terminals of the power source module; and
a load module connected between the two output terminals of the power source module, the load module comprising at least two load units connected in parallel with each other, each of the at least two load units comprising a plurality of LEDs connected in series with each other, and at least one of the at least two load units comprising a resistor connected with the LEDs therein.

2. The circuit of claim 1, wherein the at least two load units comprises a first load unit with a plurality of first LEDs connected in series, and a second load unit with a plurality of second LEDs connected in series, and the second load unit comprises a first resistor connected in series with the second LEDs.

3. The circuit of claim 2, wherein the at least two load units further includes a third load unit.

4. The circuit of claim 3, wherein the third load unit comprises a plurality of third LEDs connected in series with each other.

5. The circuit of claim 4, wherein the third load unit further comprises a second resistor connected in series with the third LEDs.

6. The circuit of claim 5, wherein a resistance of the second resistor is different from a resistance of the first resistor.

7. The circuit of claim 1, wherein the SCR is configured for adjust a phase angle of an AC supply voltage received by the power source module, and thereby adjusting an output voltage of the power source module.

8. The circuit of claim 1, wherein the resistor is configured as a current limiting resistor to make currents flowing through the at least two load units are substantially different.

9. An apparatus, comprising:
a silicon controlled rectifier (SCR) for adjusting an phase angle of an alternate current (AC) supply voltage;
a power source module connected to the SCR, and configured for receiving the AC supply voltage adjusted by the SCR;
a load module connected to the power source module, the load module comprising at least two load units connected in parallel with each other, each of the at least two load units comprising a plurality of LEDs connected in series with each other, and at least one of the at least two load units comprising a resistor connected with the LEDs therein.

10. The apparatus of claim 9, wherein the at least two load units comprises a first load unit with a plurality of first LEDs connected in series, and a second load unit with a plurality of second LEDs connected in series, and the second load unit comprises a first resistor connected in series with the second LEDs.

11. The apparatus of claim 10, wherein the at least two load units further includes a third load unit.

12. The apparatus of claim 11, wherein the third load unit comprises a plurality of third LEDs connected in series with each other.

13. The apparatus of claim 12, wherein the third load unit further comprises a second resistor connected in series with the third LEDs.

14. The apparatus of claim 13, wherein the third load unit further comprises a second resistor connected in series with the third LEDs.

15. The apparatus of claim 14, wherein a resistance of the second resistor is different from a resistance of the first resistor.

16. The apparatus of claim 9, wherein the resistor is configured as a current limiting resistor to make currents flowing through the at least two load units are substantially different.
